(19) United States
(12) Patent Application Publication
(10) Pub. No.: US 2026/0106315 A1
(43) Pub. Date: Apr. 16, 2026

(54) BATTERY PACK AND VEHICLE INCLUDING THE SAME

(71) Applicants: Hyundai Motor Company, Seoul (KR); Kia Corporation, Seoul (KR)

(72) Inventors: Seok Eun YOON, Hwaseong-si (KR); Jun Young KANG, Hwaseong-si (KR); Young Hoo OH, Hwaseong-si (KR)

(21) Appl. No.: 19/199,878

(22) Filed: May 6, 2025

(30) Foreign Application Priority Data
Oct. 14, 2024 (KR) 10-2024-0139760

(51) Int. Cl. H01M 50/383; H01M 50/209; H01M 50/249; H01M 50/342; H01M 50/358

(52) U.S. Cl. CPC H01M 50/383; H01M 50/209; H01M 50/249; H01M 50/3425; H01M 50/358; H01M 2220/20

(57) ABSTRACT

A battery pack for a vehicle includes a cell assembly including stacked battery cells, where each battery cell has a vent defined at a side surface thereof facing in a width direction of the vehicle, and a side member that accommodates the cell assembly and covers a side surface portion of the cell assembly, where the side member has a venting path configured to outwardly discharge a material vented from the cell assembly.

### CROSS-REFERENCE TO THE RELATED APPLICATION

This application claims priority from Korean Patent Application No. 10-2024-0139760, filed on Oct. 14, 2024, in the Korean Intellectual Property Office, the disclosure of which is incorporated herein by reference in its entirety.

### TECHNICAL FIELD

The present disclosure relates to a battery pack including a cell assembly of a plurality of battery cells each having a vent, and a vehicle including the battery pack.

### BACKGROUND

A battery may store electrical energy and discharge the stored electrical energy for utilization of electrical energy for reduction of carbon emissions. A performance of the battery may be enhanced in order to sufficiently store electrical energy and to use the stored electrical energy without inconvenience. In some cases, an enhancement in the performance of the battery may cause a problem of degradation of stability.

In some cases of batteries used in vehicles, industrial fields, homes, etc., the battery may be manufactured in the physical unit of a pack. For instance, a battery pack may include a battery case and a plurality of battery cells accommodated in the battery case in a sealed state. In some cases, the battery pack may perform functions for preventing spread of fire to an outside thereof when the fire is generated due to an accident such as thermal runaway of the battery cells in the battery pack and protecting the battery cells in order to prevent the battery cells from being degraded due to influence of external environments or from being damaged due to physical causes.

In some cases, when thermal runaway (TR) is generated at a battery cell in the battery pack, flame, gas, and heat may be discharged from the battery cell and flow at an inside of the battery pack. Due to such flow, the heat or flame may spread to an adjacent battery cell in the battery pack. As a result, chain thermal runaway of the battery cells in the battery pack may occur.

### SUMMARY

The present disclosure describes a battery pack including a cell assembly of a plurality of battery cells that are stacked and each have a vent at a side surface thereof, and a side member that accommodates the cell assembly and covers a side surface portion of the cell assembly, where the side member has a venting path at an inside thereof to outwardly discharge a material vented from the cell assembly. A vehicle may include the battery pack. According to one aspect of the subject matter described in this application, a battery pack includes a cell assembly comprising a plurality of battery cells that are stacked in the cell assembly, where each of the plurality of battery cells has a vent that is defined at one of side surfaces thereof. The battery pack includes a pack case that accommodates the cell assembly, where the pack case includes a side member that is disposed inside the pack case and covers a side surface portion of the cell assembly, the side member having a venting path defined at an inside of the side member and configured to guide a vented material from the cell assembly. The pack case further includes a discharge device that is fluidly connected with the venting path of the side member and configured to discharge the vented material.

Implementations according to this aspect can include one or more of the following features. For example, the vents of adjacent battery cells among the plurality of battery cells face opposite sides of the cell assembly, respectively. In some implementations, the battery pack includes an electrode assembly that is disposed inside each of the plurality of battery cells, where the vent is defined at the one of the opposite side surfaces of each of the plurality of battery cells facing an end of the electrode assembly.

In some implementations, each battery cell of the plurality of battery cells comprises a cathode terminal and an anode terminal that are disposed at an upper surface of the battery cell and spaced apart from each other in a lateral direction of the battery cell, where the vent is disposed closer to the cathode terminal than to the anode terminal. In some examples, the battery pack further includes a bus bar disposed at an upper portion of the cell assembly and configured to electrically interconnect the plurality of battery cells, where the bus bar is spaced apart from the vents of the plurality of battery cells.

In some implementations, the cell assembly includes a side plate that covers the side surfaces of the plurality of battery cells and that defines vent holes. In some examples, the vent holes are defined at positions corresponding to the vents of the plurality of battery cells, respectively. In some implementations, the battery pack includes a first cover panel that is coupled to the side plate and covers the vent holes.

In some examples, the first cover panel defines first tearable lines at positions corresponding to the vent holes, respectively, where the first tearable lines are configured to be torn by a pressure applied by the vented material of the cell assembly. In some implementations, each of the first tearable lines has a fish bone shape or a linear shape that is bent multiple times. In some implementations, the first cover panel further defines first openable portions that are arranged along the first tearable lines and configured to be opened based on the first tearable lines being torn.

In some implementations, the battery pack further includes a first sealing film that is coupled to the side plate and covers the vent holes. In some implementations, the side member is an extruded product having a cavity therein. In some implementations, the side member defines a communication hole at a side surface of the side member facing the side surface portion of the cell assembly, where the communication hole is fluidly connected with the venting path. In some examples, the communication hole is defined at a position corresponding to the vent of the cell assembly.

In some implementations, the battery pack includes a second cover panel that is coupled to the side member and covers the communication hole. In some examples, the second cover panel defines a second tearable line at a position corresponding to the communication hole, where the second tearable line is configured to be torn by a pressure applied by the vented material of the cell assembly. In some implementations, the battery pack includes a second sealing film that is coupled to the second cover panel and covers the communication hole.

In some implementations, the cell assembly is one of a plurality of cell assemblies that are arranged at the battery pack, where the side member covers side surface portions of the plurality of cell assemblies and is fluidly connected with the discharge device at one end of the side member.

According to another aspect, a vehicle includes the battery pack having one or more of the features described above.

### BRIEF DESCRIPTION OF THE DRAWINGS

The above and other objects, features and other advantages of the present disclosure will be more clearly understood from the following detailed description taken in conjunction with the accompanying drawings.

FIG. 1 is a view showing an example of a battery cell.

FIG. 2 is an exploded perspective view of the battery cell.

FIG. 3 is a view showing an example of a cell assembly.

FIG. 4 is a view showing the battery cells to be mounted to the cell assembly.

FIG. 5 is a front view showing an example of a side plate.

FIG. 6 and FIG. 7 are views showing examples of the side plate, a first cover panel, and a first sealing film.

FIG. 8 is a view showing an example of a battery pack.

FIG. 9 is a cross-sectional view taken along line A-A in FIG. 8;

FIG. 10 is a view showing an example of a side member.

FIG. 11 and FIG. 12 are views showing examples of a second cover panel and a second sealing film.

FIG. 13 is a view showing an example of a vehicle including a battery pack.

### DETAILED DESCRIPTION

Hereinafter, one or more implementations of the present disclosure will be described in detail with reference to the accompanying drawings, and the same or similar elements are designated by the same reference numerals regardless of the numerals in the drawings and redundant description thereof will be omitted.

In some examples, batteries can be used in vehicles, industrial fields, homes, etc., and such a battery can be manufactured in the physical unit of a pack. A battery pack can include a battery case and a plurality of battery cells accommodated in the battery case in a sealed state. In some examples, the battery pack performs functions for preventing spread of fire to an outside thereof even when the fire is generated due to an accident such as thermal runaway of the battery cells in the battery pack and protecting the battery cells in order to prevent the battery cells from being degraded due to influence of external environments or from being damaged due to physical causes.

A plurality of battery cells is accommodated in a battery pack while having an intermediate form of a module or a cell module assembly (CMA). For example, a plurality of battery cells is assembled to constitute one module or one assembly, and a plurality of modules or assemblies constituted as described above is fastened to an inside of a pack case and, as such, a battery pack is completed. In some examples, battery maintenance can be carried out on a module or assembly basis, and, as such, easy maintenance and repair of the battery pack can be achieved.

In some cases, a battery cell can be degraded due to errors generated during manufacture thereof, excessive charging and recharging thereof, or aging thereof. When degradation of the battery cell is continued, fire can be generated at last.

In particular, when thermal runaway (TR) is generated at a particular battery cell in one module or assembly of the battery pack, a material including strong flame, gas, and heat can be discharged from the battery cell and, as such, thermal runaway can spread from the battery cell to an adjacent battery cell in the module or assembly. Furthermore, the material discharged from the battery cell, at which thermal runaway has occurred, can flow at an inside of the battery pack. As a result, thermal runaway can also spread to another module or assembly adjacent to the module or assembly at which the thermal runaway has occurred. Consequently, simultaneous thermal runaway of the battery pack can occur.

In some implementations, a battery pack can be configured to effectively guide and discharge, to an outside thereof, a material, to be vented, including flame, gas, and heat discharged from a particular battery cell thereof while preventing the material from influencing another battery cell adjacent to the particular battery cell.

The present disclosure describes a battery pack including a cell assembly that includes a plurality of battery cells that are stacked and each have a vent defined at a side surface thereof. The battery pack includes a side member that accommodates the cell assembly and covers a side surface portion of the cell assembly, where the side member has a venting path defined at an inside thereof and configured to outwardly discharge a material vented from the cell assembly. The present disclosure further describes a vehicle including the battery pack.

In accordance with the present disclosure, the present disclosure is applicable to a variety of vehicles configured such that a battery is coupled to a lower portion of a vehicle body, such as an electric vehicle, a fuel cell vehicle, a hybrid vehicle, etc. Although an electric vehicle is illustrated in the present disclosure, for convenience of description, it will be appreciated that any vehicle falls within the scope of the present disclosure, irrespective of the kind thereof, so long as a battery pack is mounted in the vehicle.

In some implementations, a battery cell can have various shapes in addition to a pouch type, a cylindrical shape, and a quadrangular shape. Although a quadrangular battery cell is illustrated in the present disclosure, for convenience of description, it should be understood that the battery cell according to the present disclosure can have various shapes in addition to the pouch type, the cylindrical shape, and the quadrangular shape.

In some implementations, a plurality of battery cells are stacked and can define one stack, one assembly, or one bank of battery cells. Such a group of battery cells will be collectively referred to as a “cell assembly.” Although a battery module is illustrated in the present disclosure, for convenience of description, the cell assembly according to the present disclosure should be understood as a group of a plurality of grouped battery cells, such as a battery stack, a battery module, a battery bank, a cell-to-pack, and the like. In addition, the battery pack should be understood to be constituted by at least one battery module.

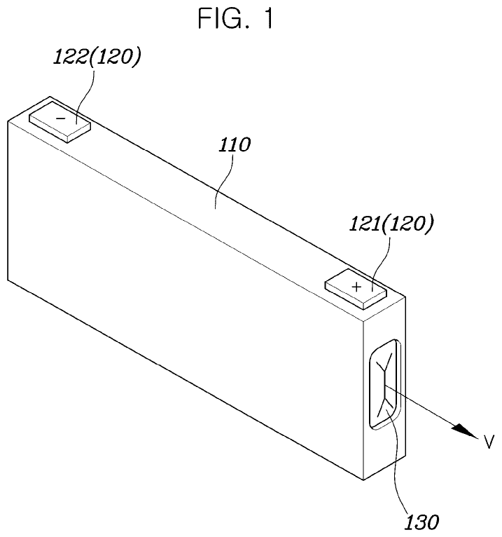

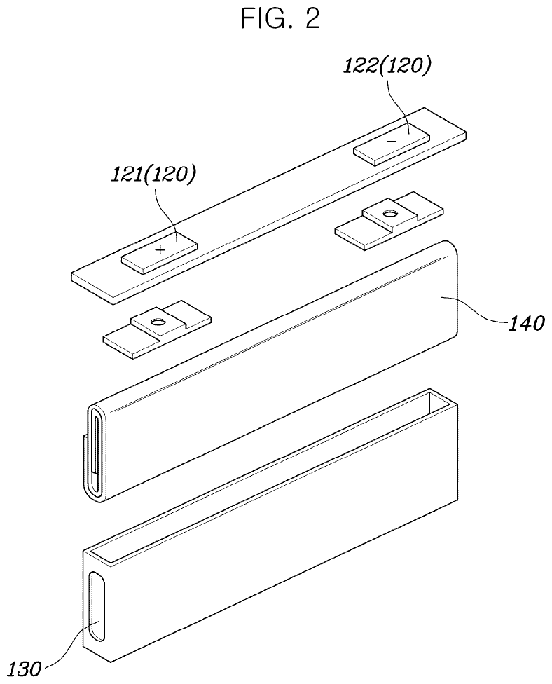

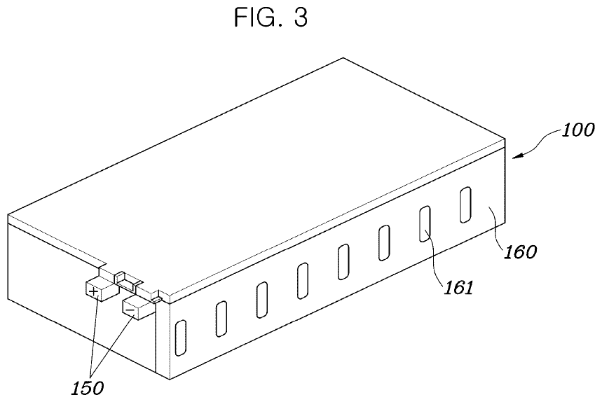

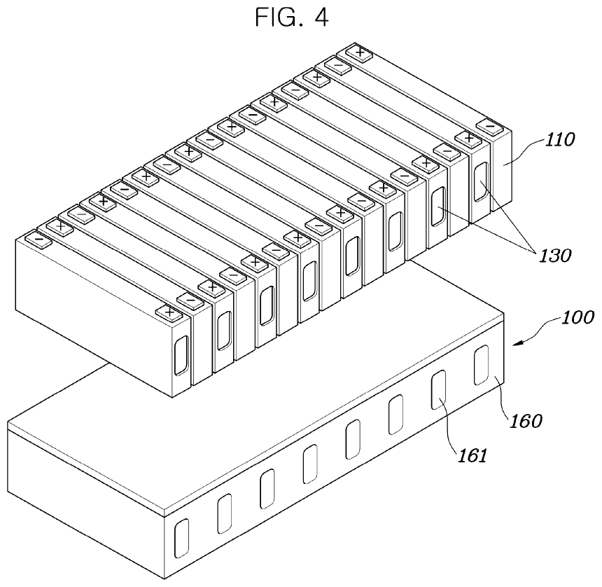

FIG. 1 is a view showing an example of a battery cell. FIG. 2 is an exploded perspective view of the battery cell. FIG. 3 is a view showing a cell assembly. FIG. 4 is a view explaining a battery cell mounted in the cell assembly. Hereinafter, the battery pack of the present disclosure will be described with reference to the above-described drawings.

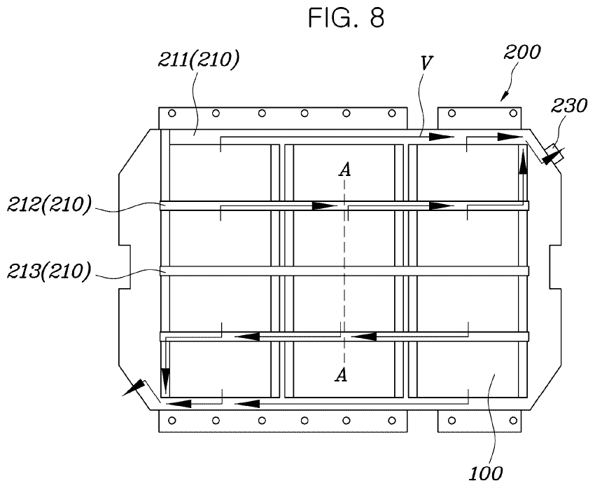

The battery pack can include a cell assembly 100 including stacked battery cells 110 that each have a vent 130 defined at a side surface thereof, and a pack case 200 (see FIG. 8) that accommodates the cell assembly 100 and includes a side member 210 that covers a side surface portion of the cell assembly 100. The side member 120 has a venting path 220 defined within an inside of the side member 210 and configured to guide a material vented from the cell assembly 100 through the venting path 220. The pack case 200 can include a discharge device 230 that is fluidly connected with the venting path 220 of the side member 210 and configured to outwardly discharge the vented material.

In some implementations, each battery cell 110 can have the vent 130 at the side surface thereof.

In the implementation shown in FIG. 1, the vent 130 can be defined at the side surface of the battery cell 110 and have a predetermined shape. The vent 130 can have a smaller thickness than that of other portions of the battery cell 110, or can be formed with a tearable line. When thermal runaway occurs in the battery cell 110, the vent 130 is ruptured, and, as such, a material V, to be vented, including hot flame, gas, and heat can be discharged outwards from the battery cell 110 through the vent 130.

In some implementations, the battery cell 110 can have the vent 130 defined at one of opposite side surfaces thereof. In addition, a pair of battery cells 110 adjacent to each other can be stacked such that the vents 130 thereof are disposed at opposite sides, respectively.

Referring to the implementation shown in FIG. 4, a plurality of battery cells 110 can be stacked in the cell assembly 100. Each pair of battery cells 110 adjacent to each other can be stacked such that the vents 130 thereof are disposed at opposite sides, respectively. Accordingly, a material to be vented can be discharged in a state of being distributed to opposite sides of the cell assembly 100, and the distance between the vents 130 adjacent to each other can be increased. As a result, it can be possible to minimize influence of thermal runaway between the adjacent battery cells 110.

Through such a structure, it can be possible to prevent the material V to be vented from being discharged in a state of being concentrated in a particular direction or on a particular point and to prevent heat generated due to thermal runaway from being concentrated in a particular direction or on a particular point. In addition, as the distance between the adjacent vents 130 increases, it can be possible to minimize influence of thermal runaway applied from a particular battery cell 110, at which the thermal runaway has occurred, to another battery cell 110 adjacent to the particular battery cell 110 and to effectively prevent acceleration of thermal runaway.

In some implementations, an electrode assembly 140 can be provided within the battery cell 110. The vent 130 can be formed at a side surface of the battery cell 110 facing an end of the electrode assembly 140. The electrode assembly 140 can be formed through stacking of a separation plate between a cathode and an anode. The electrode assembly 140 can be provided within the battery cell 110 in a Z-stacking or winding manner. As the electrode assembly 140 is provided in the above-described manner, the electrode assembly 140 can be effectively received in the battery cell 110 in a state of being increased in length or size for an increase in capacity of the battery cell 110.

For example, the vent 130 can be formed at the side surface of the battery cell 110 facing the end of the electrode assembly 140.

When the vent 130 is disposed at an upper portion or a lower portion of the battery cell 110, discharge of the material to be vented can be impeded by the wound electrode assembly 140. As a result, the internal pressure of the battery cell 110 can be increased and, as such, explosion and additional damage of the electrode assembly 140 can occur. However, when the vent 130 is disposed at the side surface of the battery cell 110 facing the end of the electrode assembly 140, the material to be vented can be effectively discharged without being impeded by the electrode assembly 140.

In the implementation shown in FIG. 2, the electrode assembly 140 can be received in the battery cell 110 in a wound state. The vent 130 can be formed at the side surface of the battery cell 110 facing the end of the electrode assembly 140.

In some implementations, when a short circuit is generated in the battery cell 110, abrupt movement of electrons from an anode to a cathode is generated and, as such, explosive thermal reaction and thermal decay can be generated in the vicinity of a cathode terminal 121. As a result, a material to be vented can be generated in a greater amount in the vicinity of the cathode terminal 121 than in the vicinity of an anode terminal 122.

In the implementation shown in FIG. 2, the battery cell 110 can be formed, at an upper surface thereof, with electrode terminals 120 respectively including the cathode terminal 121 and the anode terminal 122. The cathode terminal 121 and the anode terminal 122 can be disposed to be spaced apart from each other in opposite lateral directions of the battery cell 110, and the vent 130 can be formed at a side surface of the battery cell 110 adjacent to the cathode terminal 121. Through such a structure, it can be possible to effectively outwardly discharge, from the battery cell 110, a material, to be vented, generated in a relatively great amount in the vicinity of the cathode terminal 121.

In some implementations, in the cell assembly 100 in which a plurality of battery cells 110 is stacked, bus bars 150 can be provided to electrically interconnect the plurality of battery cells 110. The bus bars 150 can be provided at an upper portion of the cell assembly 100 while being spaced apart from the vents 130.

In the implementation shown in FIG. 3, the cell assembly 100 can be covered at the upper portion thereof, and the bus bars 150 can be provided at the upper portion of the cell assembly 100 such that the bus bars 150 protrude at an upper end of a front portion of the cell assembly 100. The vent 130 of each battery cell 110 can be disposed at a side surface of the battery cell 110. Through such a structure, the vent 130 and the bus bars 150 can be spaced apart from each other and, as such, it can be possible to prevent the bus bars 150 from being exposed to the vented material discharged through the vent 130. Accordingly, accumulation of the vented material on the bus bars 150 can be prevented. Thus, a short circuit possibly generated due to accumulation of the vented material on the bus bars 150 can be effectively prevented.

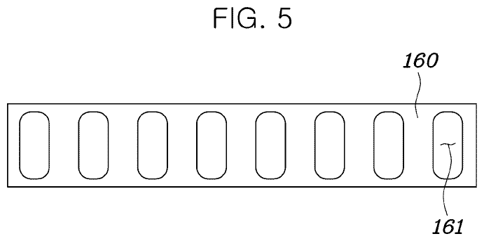

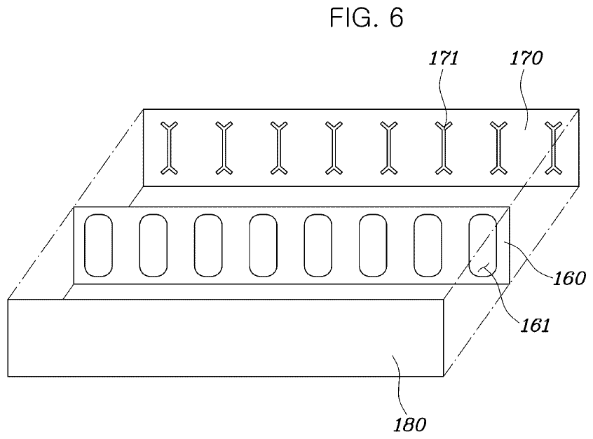

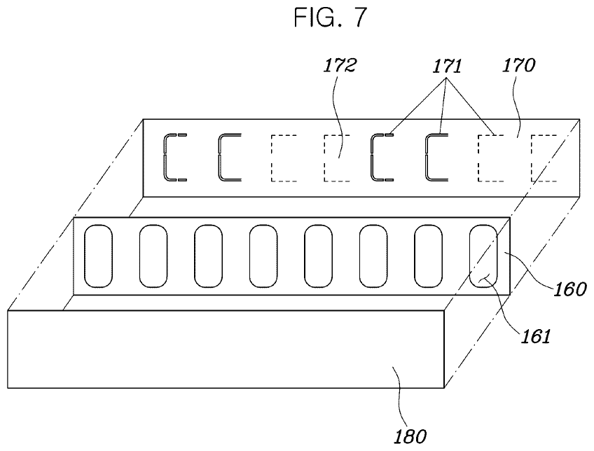

FIG. 4 is a view explaining battery cells mounted in the cell assembly. FIG. 5 is a front view of a side plate. FIG. 6 and FIG. 7 are views showing examples of the side plate, a first cover panel, and a first sealing film of the present disclosure. The battery pack of the present disclosure will be described mainly in conjunction with the side plate with reference to the above-described drawings.

In the battery pack, a side plate 160 configured to cover a side surface of the battery cell 110 can be provided at the cell assembly 100. The side plate 160 can be formed of a material having relatively high hardness in order to protect side surfaces of a plurality of battery cells 110 stacked in the cell assembly 100. In particular, when the cell assembly 100 is mounted in a vehicle, performance against collision should be secured. Furthermore, when fire or thermal runaway occurs, spread thereof should be prevented. In some examples, the side plate 160 can be made of a metal material and can then be shaped. The side plate 160 can be manufactured and shaped using aluminum having a light weight while securing shapeability, among metal materials. A plurality of vent holes 161 spaced apart from one another can be formed at the side plate 160.

Referring to the implementation shown in FIG. 3 and FIG. 5, side plates 160 can be provided at side surfaces of the cell assembly 100, respectively, and a plurality of vent holes 161 spaced apart from one another can be formed at each side plate 160.

Referring to the implementation shown in FIG. 4, as described above, the plurality of battery cells 110 can be stacked such that the vents 130 of each pair of battery cells 110 adjacent to each other are disposed at opposite sides, respectively, and the side plates 160 can be disposed to cover side surfaces of the battery cells 110. Vent holes 161 can be formed through each side plate 160 at positions corresponding to respective vents 130 in order to effectively discharge a vented material.

In some implementations, a first cover panel 170 configured to cover the vent holes 161 can be coupled to each side plate 160. The first cover panel 170 can have a shape corresponding to that of the side plate 160, and can be coupled to one side surface of the side plate 160.

The first cover panel can be made of a material including one of mica, aluminum (Al), stainless steel (SUS), and a mixture thereof. This is only illustrative, and a variety of material capable of securing heat resistance can be selected and used.

In the implementations shown in FIG. 6 and FIG. 7, the first cover panel 170 can have a shape corresponding to that of the side plate 160, and can be coupled to the side plate 160 while covering one side surface of the side plate 160. The first cover panel 170 can have a single plate structure, or can be an assembly constituted by a plurality of plates configured to cover respective vent holes 161 of the side plate 160.

In some implementations, the first cover panel 170 can be formed with first tearable lines 171 at positions corresponding to the vent holes 161, respectively. The first tearable lines 171 can be torn by a pressure applied by the vented material of the cell assembly 100.

In the implementations shown in FIG. 6 and FIG. 7, each first tearable lines 171 can have a fish bone shape or a line shape bent multiple times. First openable portions 172 can be formed at the first cover panel 170 along respective first tearable lines 171. When the first tearable lines 171 are torn, the first openable portions 172 are opened and, as such, a vented material can be discharged outwards from the cell assembly 100.

In some implementations, a first sealing film 180 can be coupled to the first cover panel 170 to cover the first cover panel 170. Since the vent holes 161 are formed at the side plate 160, and the first tearable lines 171 are formed at the first cover panel 170, it can be difficult to secure sealing. As the first sealing film 180 is coupled to the first cover panel 170, it can be possible to easily secure sealing of the cell assembly 100.

The first sealing film 180 can be a film made of polyimide. This is only illustrative, and the first sealing film 180 is not limited to the above-described material. A variety of materials capable of covering the vent holes 161, thereby securing sealing of the cell assembly 100, can be used.

In the implementations shown in FIG. 6 and FIG. 7, the first sealing film 180 can be coupled to a side surface of the side plate 160 opposite to a side surface of the side plate 160 to which the first cover panel 170 is coupled. In some implementations, the first sealing film 180 can be coupled to the first cover panel 170 such that the first sealing film 180 can be disposed at an outer surface of the cell assembly 100.

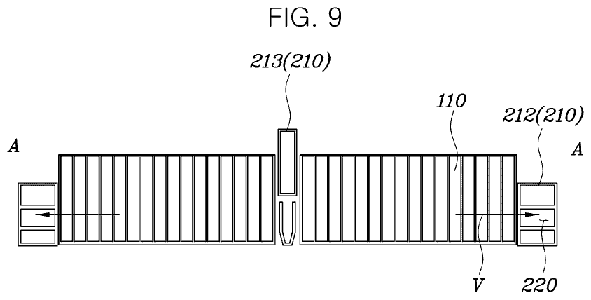

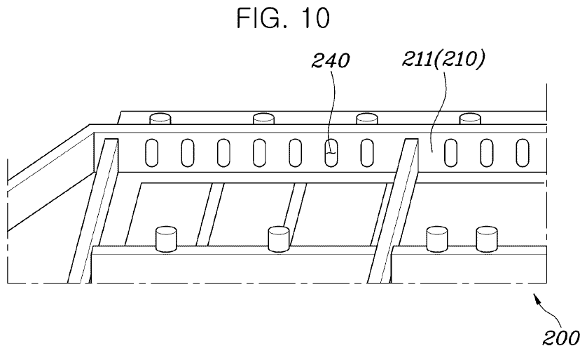

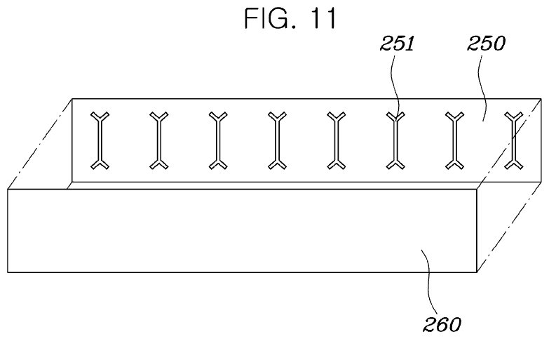

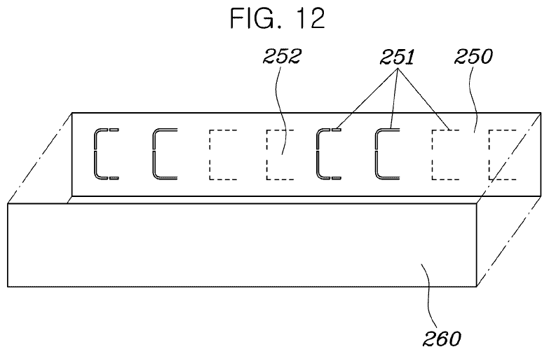

FIG. 8 is a view explaining a battery pack. FIG. 9 is a cross-sectional view taken along line A-A in FIG. 8. FIG. 10 is a view explaining a side member. FIG. 11 and FIG. 12 are views showing examples of a second cover panel and a second sealing film according to the present disclosure. Hereinafter, the battery pack of the present disclosure will be described mainly in conjunction with the side member with reference to the above-described drawings.

In some implementations, the battery pack can be manufactured through mounting of a plurality of cell assemblies 100 in the pack case 200. The pack case 200 can have a housing shape having an inner space. The pack case 200 can be made of a material having relatively high hardness in order to protect the cell assemblies 100 mounted therein. In particular, in the case of a battery pack configured to be mounted in a vehicle, the battery pack should secure performance against collision. Furthermore, when fire is generated in the battery pack, spread thereof to an outside of the battery pack should be prevented. In some examples, the pack case 200 can be made of a metal material and can then be shaped. In addition, lightness of the pack case 200 can be provided for an increase in energy density of the battery pack. The pack case 200 can be manufactured and shaped using aluminum having a light weight while securing shapeability, among metal materials. This is only illustrative, and the material of the pack case 200 of the present disclosure is not limited to the above-described material.

In some implementations, the side member 210 can include an outer side member 211 disposed at an outer peripheral portion of the pack case 200, and an inner side member 212 disposed at an inside of the battery pack to define an inner space in which the cell assemblies 100 are installed.

In the implementation shown in FIG. 8, the outer side member 211 can be disposed at the outer peripheral portion of the pack case 200 and, as such, can protect the cell assemblies 100 mounted in the battery pack from external impact. In addition, the inner side member 212 can isolate the plurality of cell assemblies 100 installed in the battery pack from one another, thereby preventing thermal runaway occurring at a particular one of the cell assemblies 100 from spreading to another cell assembly 100 adjacent to the particular cell assembly 100. In addition, venting paths 220 can be provided at insides of the outer side member 211 and the inner side member 212, respectively, and can communicate with each other such that the venting paths 220 guide a vented material V discharged from the particular cell assembly 100 to be discharged outwards from the battery pack. In some examples, the battery pack can also be provided with a discharge device 230 configured to communicate with the venting paths 220, thereby outwardly discharging the vented material V.

In more detail, the plurality of cell assemblies 100 can be continuously disposed, and the side member 210 can simultaneously cover the side surface portions of the plurality of cell assemblies 100 while communicating with the discharge device 230 at one end thereof. The discharge device 230 can be a device including a valve, a membrane, or the like configured to be fractured at a predetermined pressure or temperature or more, thereby allowing a vented material V to be outwardly discharged therethrough. The discharge device 230 can have a particular structure.

In some implementations, the side member 210 can be an extruded product formed with a cavity therein. The cavity can be formed in the same direction as the direction in which the side member 210 is extruded. The cavity can be a venting path 220.

In the implementation shown in FIG. 9, a venting path 220 can be formed at an inside of the inner side member 212. Since the inner side member 210 has a hollow structure, and, as such, lightness thereof can be achieved, and a cavity in the inner side member 210 can be used as the venting path 220, a separate structure may not be provided for formation of the venting path 220. As such, process simplicity, cost reduction, and lightness can be achieved. In addition, a barrier member 213 can be formed between adjacent ones of the cell assemblies 100. Accordingly, when thermal runaway occurs at one cell assembly 100, it can be possible to prevent the thermal runaway from spreading to another cell assembly 100 adjacent to the former cell assembly 100. In addition, the venting path 220 is not provided at an inside of the barrier member 213. Accordingly, parts of the battery pack to be protected from a vented hot material can be provided at the barrier member 213. Such parts can be disposed at the inside of the barrier member 213. In particular, the parts can be disposed in a space formed through indentation of an upper surface of the barrier member 213.

In some implementations, a communication hole 240 can be formed at the side member 210.

In the implementation shown in FIG. 10, the communication hole 240 can be formed at an inner side surface of the outer side member 211 facing a side surface portion of the cell assembly 100 such that the communication hole 240 communicates with the venting path 220 of the outer side member 211. The communication hole 240 can be provided in plural such that the plurality of communication holes 240 is spaced apart from one another. The communication holes 240 can be formed at positions corresponding to vents 130 of the cell assembly 100, respectively.

In some implementations, a second cover panel 250 can be coupled to the side member 210 to cover the communication holes 240. The second cover panel 250 can be coupled to a side surface of the side member 210 facing the cell assembly 100.

In the implementations shown in FIG. 11 and FIG. 12, the second cover panel 250 can have a single plate structure, or can be an assembly constituted by a plurality of plates configured to cover respective communication holes 240.

In some implementations, the second cover panel 250 can be formed with second tearable lines 251 at positions corresponding to the communication holes 240, respectively. The second tearable lines 251 can be torn by a pressure applied by a vented material of the cell assembly 100.

In the implementations shown in FIG. 11 and FIG. 12, a plurality of second tearable lines 251 can be formed to be spaced apart from one another. Each second tearable lines 251 can have a fish bone shape or a line shape bent multiple times. Second openable portions 252 can be formed at the second cover panel 250 along respective second tearable lines 251. When the second tearable lines 251 are torn, the second openable portions 252 are opened and, as such, a vented material can be discharged outwards.

In some implementations, a second sealing film 260 can be coupled to the second cover panel 250 to cover the second cover panel 250 and the communication holes 240. Since the communication holes 240 are formed at a side surface portion of the side member 210, and the second tearable lines 251 are formed at the second cover panel 250, it can be difficult to secure sealing. As the second sealing film 260 is coupled to the second cover panel 250, it can be possible to easily secure sealing of the side member 210, to which the second cover panel 250 is coupled, and sealing of the battery pack including the side member 210.

The second sealing film 260 can be a film made of polyimide. This is only illustrative, and the second sealing film 260 is not limited to the above-described material. A variety of materials capable of covering the communication holes 240, thereby securing sealing of the side member 210 and the battery pack including the side member 210, can be used.

In the implementations shown in FIG. 11 and FIG. 12, the second sealing film 260 can be coupled to one side surface of the second cover panel 250. This is only illustrative, and the second sealing film 260 can be coupled to one side surface of the side member 210.

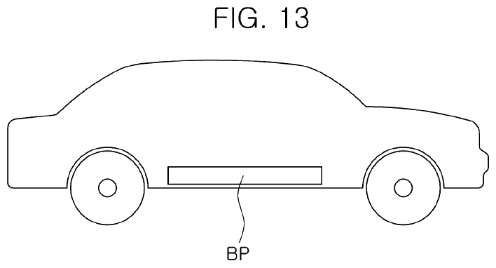

FIG. 13 is a view showing a vehicle in which a battery pack is mounted. The vehicle including the battery pack of the present disclosure will be described with reference to the above-described drawing.

The battery pack can be applied to a battery pack BP of a variety of vehicles V such as an internal combustion engine vehicle, an electric vehicle, a hybrid vehicle, a fuel cell vehicle, etc. In addition to the vehicles V, the battery pack can be applied to a battery pack BP in various fields such as an energy storage system (ESS) for industrial purposes, an ESS for domestic purposes, a small-size battery pack, etc. In accordance with the battery pack of the present disclosure and the vehicle including the same, a material vented after being generated in the battery pack can be effectively discharged outwards and, as such, chain thermal runaway of cell assemblies in the battery pack can be prevented. Thus, stability of the battery pack can be greatly enhanced.

Effects attainable in the present disclosure are not limited to the above-described effects, and other effects of the present disclosure not yet described will be more clearly understood by those skilled in the art from the above detailed description.

Although the implementations of the present disclosure have been disclosed for illustrative purposes, those skilled in the art will appreciate that various modifications, additions and substitutions are possible, without departing from the scope and spirit of the disclosure as disclosed in the accompanying claims.

What is claimed is:

1. A battery pack comprising:
a cell assembly comprising a plurality of battery cells that are stacked in the cell assembly, each of the plurality of battery cells having a vent that is defined at one of side surfaces thereof; and
a pack case that accommodates the cell assembly, the pack case comprising:
a side member that is disposed inside the pack case and covers a side surface portion of the cell assembly, the side member having a venting path defined at an inside of the side member and configured to guide a vented material from the cell assembly, and
a discharge device that is fluidly connected with the venting path of the side member and configured to discharge the vented material.

2. The battery pack of claim 1, wherein the vents of adjacent battery cells among the plurality of battery cells face opposite sides of the cell assembly, respectively.

3. The battery pack of claim 1, further comprising:
an electrode assembly that is disposed inside each of the plurality of battery cells,
wherein the vent is defined at the one of the opposite side surfaces of each of the plurality of battery cells facing an end of the electrode assembly.

4. The battery pack of claim 1, wherein each battery cell of the plurality of battery cells comprises a cathode terminal and an anode terminal that are disposed at an upper surface of the battery cell and spaced apart from each other in a lateral direction of the battery cell, and
wherein the vent is disposed closer to the cathode terminal than to the anode terminal.

5. The battery pack of claim 4, further comprising:
a bus bar disposed at an upper portion of the cell assembly and configured to electrically interconnect the plurality of battery cells, the bus bar being spaced apart from the vents of the plurality of battery cells.

6. The battery pack of claim 1, wherein the cell assembly comprises a side plate that covers the side surfaces of the plurality of battery cells and that defines vent holes.

7. The battery pack of claim 6, wherein the vent holes are defined at positions corresponding to the vents of the plurality of battery cells, respectively.

8. The battery pack of claim 6, further comprising a first cover panel that is coupled to the side plate and covers the vent holes.

9. The battery pack of claim 8, wherein the first cover panel defines first tearable lines at positions corresponding to the vent holes, respectively, the first tearable lines being configured to be torn by a pressure applied by the vented material of the cell assembly.

10. The battery pack of claim 9, wherein each of the first tearable lines has a fish bone shape or a linear shape that is bent multiple times.

11. The battery pack of claim 10, wherein the first cover panel further defines first openable portions that are arranged along the first tearable lines and configured to be opened based on the first tearable lines being torn.

12. The battery pack of claim 6, further comprising a first sealing film that is coupled to the side plate and covers the vent holes.

13. The battery pack of claim 1, wherein the side member is an extruded product having a cavity therein.

14. The battery pack of claim 1, wherein the side member defines a communication hole at a side surface of the side member facing the side surface portion of the cell assembly, the communication hole being fluidly connected with the venting path.

15. The battery pack of claim 14, wherein the communication hole is defined at a position corresponding to the vent of the cell assembly.

16. The battery pack of claim 14, further comprising a second cover panel that is coupled to the side member and covers the communication hole.

17. The battery pack of claim 16, wherein the second cover panel defines a second tearable line at a position corresponding to the communication hole, the second tearable line being configured to be torn by a pressure applied by the vented material of the cell assembly.

18. The battery pack of claim 16, further comprising a second sealing film that is coupled to the second cover panel and covers the communication hole.

19. The battery pack of claim 1, wherein the cell assembly is one of a plurality of cell assemblies that are arranged at the battery pack,
wherein the side member covers side surface portions of the plurality of cell assemblies and is fluidly connected with the discharge device at one end of the side member.

20. A vehicle comprising the battery pack of claim 1.
